(19) United States
(12) Patent Application Publication
(10) Pub. No.: US 2023/0278147 A1
(43) Pub. Date: Sep. 7, 2023

(54) GANTRY-TYPE THERMAL CUTTING SYSTEM WITH MOBILE COLLECTION BIN

(71) Applicant: Benjamin G Stroyer, East Rochester, NY (US)

(72) Inventor: Benjamin G Stroyer, East Rochester, NY (US)

(21) Appl. No.: 18/122,412

(22) Filed: Mar. 16, 2023

Related U.S. Application Data
(63) Continuation of application No. PCT/US2023/014874, filed on Mar. 9, 2023.
(60) Provisional application No. 63/314,433, filed on Feb. 27, 2022.
(60) Provisional application No. 63/314,512, filed on Feb. 28, 2022.
(60) Provisional application No. 63/315,206, filed on Mar. 1, 2022.

(51) Int. Cl. B23K 37/02

(52) U.S. Cl. CPC B23K 37/0288; B23K 10/00

(57) ABSTRACT

A gantry-type thermal cutting system includes a gantry; a thermal cutting device located on the gantry; a cutting table having a grated steel sheet; and a waste hopper removably connected to the gantry. The gantry is configured to move bi-directionally in a first direction. The thermal cutting device is configured to move bi-directionally in a second direction, the first direction being orthogonal to the second direction. The waste hopper is configured to move synchronously with the gantry in the first direction. The waste hopper is positioned under the gantry to capture waste from a thermal cutting process performed by the thermal cutting device.

### PRIORITY INFORMATION

The present application is a continuation application of PCT Patent Application Number PCT/US2023/014874, filed on Mar. 9, 2023, and claiming priority, under 35 U.S.C. § 120, from PCT Patent Application Number PCT/US2023/014874, filed on Mar. 9, 2023; said PCT Patent Application Number PCT/US2023/014874, filed on Mar. 9, 2023, claiming priority, 35 U.S.C. § 365(c), from U.S. Provisional Patent Application, Ser. No. 63/314,433, filed on Feb. 27, 2022; said PCT Patent Application Number PCT/US2023/014874, filed on Mar. 9, 2023, claiming priority, 35 U.S.C. § 365(c), from U.S. Provisional Patent Application, Ser. No. 63/314,512, filed on Feb. 28, 2022; and said PCT Patent Application Number PCT/US2023/014874, filed on Mar. 9, 2023, claiming priority, 35 U.S.C. § 365(c), from U.S. Provisional Patent Application, Ser. No. 63/315,206, filed on Mar. 1, 2022. The entire content of PCT Patent Application Number PCT/US2023/014874, filed on Mar. 9, 2023, is hereby incorporated by reference.

The present application claims priority, under 35 USC § 119(e), from U.S. Provisional Patent Application, Ser. No. 63/314,433, filed on Feb. 27, 2022. The entire content of U.S. Provisional Patent Application, Ser. No. 63/314,433, filed on Feb. 27, 2022, is hereby incorporated by reference.

The present application claims priority, under 35 USC § 119(e), from U.S. Provisional Patent Application, Ser. No. 63/314,512, filed on Feb. 28, 2022. The entire content of U.S. Provisional Patent Application, Ser. No. 63/314,512, filed on Feb. 28, 2022, is hereby incorporated by reference.

The present application claims priority, under 35 USC § 119(e), from U.S. Provisional Patent Application, Ser. No. 63/315,206, filed on Mar. 1, 2022. The entire content of U.S. Provisional Patent Application, Ser. No. 63/315,206, filed on Mar. 1, 2022, is hereby incorporated by reference.

### BACKGROUND

When cutting metal shapes from a large metal plate (steel), a thermal cutting system such as a Plasma, Oxy—Acetylene torch or laser has been conventionally used to cut defined shapes (pieces) from the steel plate or make holes therein.

As example of such a thermal cutting system is illustrated in FIG. 1, wherein a gantry 10, holding a thermal cutting device (not shown), rides along rails 40, to bi-directionally move the gantry 10 in an X-direction. The thermal cutting device (not shown), located on the cross beam of gantry 10, may move in a Y-direction, orthogonal to the X-direction. This allows the thermal cutting device (not shown) to move two-dimensionally. A steel plate 50 sits upon a bed (cutting table) (not shown). The bed (cutting table) is usually made up of metal slats stood up on end and provides support for the steel plate 50 and allows waste (slag and remnants from the cutting process) to fall through the bed (cutting table) into waste hoppers 20 located underneath the bed (cutting table). These slats cover the length and width of the cutting area.

In the conventional thermal cutting system, there are multiple waste hoppers 20 located underneath the bed (cutting table) so that wherever the gantry 10 moves, there is a waste hopper 20 to capture the waste (slag and remnants from the cutting process). Each waste hopper 20 has, connected thereto, a ventilation conduit 35 that is connected to a central ventilation conduit 30, which is connected to a ventilation system (not shown), to draw the fumes, produced by the thermal cutting device, away from the thermal cutting process. This central ventilation conduit 30 includes valves or damper (not shown) which independently control the ventilation of each waste hopper 20.

An example of a gantry-type thermal cutting system is disclosed in Published US Patent Application Number 2020/0016678. The entire content of Published US Patent Application Number 2020/0016678 is hereby incorporated by reference.

One drawback of the conventional gantry-type thermal cutting system is the number of waste hoppers needed to capture the waste (slag and remnants from the cutting process). This type of collection system is extremely difficult to clean and maintain and is often left for weeks, allowing the weight of the waste to be such that the labor and equipment required for cleaning is excessive, thereby unnecessarily shutting down the conventional gantry-type thermal cutting system for an extended period of time.

As noted above, the bed (cutting table) provides support for the steel plate 50 and includes a steel grating that allows waste (slag and remnants from the cutting process) to fall through the bed (cutting table) into waste hoppers 20 located underneath the bed (cutting table). The conventional gantry-type thermal cutting system includes a ventilation system to service the number of waste hoppers; i.e., to draw the fumes, produced by the thermal cutting device, away from the thermal cutting system. A very large fan is used to provide enough suction to overcome the inefficiencies of the conventional gantry-type thermal cutting system. This results in poor suction towards the extremities of the cutting table from the suction fan.

Another drawback of the conventional gantry-type thermal cutting system is ventilation system needed to service the number of waste hoppers; i.e., to draw the fumes, produced by the thermal cutting, away from the thermal cutting system.

Another drawback of the conventional gantry-type thermal cutting system is the effort required to remove and replace the metal slats that make up the bed (cutting table). The slats are conventionally covering the entire cutting area; and therefore; the slag collects around the connection points and make the metal slats difficult to remove.

Further, the slats can only be removed by an overhead operation which is usually manual and requires excessive effort and sometimes over thirteen hours of labor.

A further drawback of the conventional thermal cutting system is that small parts drop through the grating of the metal slats with no practical means of retrieval, resulting in bad part counts and re-cutting small parts to make up for lost parts.

Therefore, it would be desirable to reduce the number of waste hoppers needed to capture the waste (slag and remnants from the cutting process) while maintaining the proper coverage of the bed (cutting table).

Additionally, it would be desirable to reduce the number of waste hoppers needed to capture the waste (slag and remnants from the cutting process) while maintaining the proper coverage of the bed (cutting table) and increasing suction at the “point of cut.”

Moreover, it would be desirable to reduce the number of waste hoppers needed to capture the waste (slag and remnants from the cutting process) while reducing the time needed to service a waste hopper that needs emptying.

Additionally, it would be desirable to reduce the number of waste hoppers needed to capture the waste (slag and remnants from the cutting process) while maintaining the proper coverage of the bed (cutting table) and reducing the time needed to service a waste hopper that needs emptying.

Furthermore, it would be desirable to reduce the complexity of the ventilation system while maintaining the proper coverage of the bed (cutting table).

Also, it would be desirable to remove and clean the waste effortlessly on a daily basis using a forklift, dump gate, or vacuum at a convenience access point.

It would be desirable to have open access to the hopper to collect small parts that fall through the grate.

Furthermore, it would be desirable to reduce the complexity of the ventilation system while maintaining the proper coverage of the bed (cutting table) and increasing suction at the “point of cut.”

Additionally, it would be desirable to have access to the cutting table gratings by forklift and remove entire sections of grating at a time with minimal manual labor.

Furthermore, it would be desirable to be able to effortlessly retrieve small parts that fall through the grating.

It would be desirable to provide a smoke and slag receiver that travels with the thermal cutting system that can be easily emptied.

Moreover, it would be desirable to provide a system having an open access to the cutting bed (cutting table) for removal and replacement of the slat system by a forklift requiring little to no manual labor.

Additionally, it would be desirable to provide a smoke and slag receiver that travels with the thermal cutting system that can be easily emptied and to provide a system having an open access to the bed (cutting table) for removal and replacement of the slat system by a forklift requiring little to no manual labor.

### BRIEF DESCRIPTION OF THE DRAWINGS

The drawings are only for purposes of illustrating various embodiments and are not to be construed as limiting, wherein:

FIG. 1 illustrates a conventional gantry-type thermal cutting system;

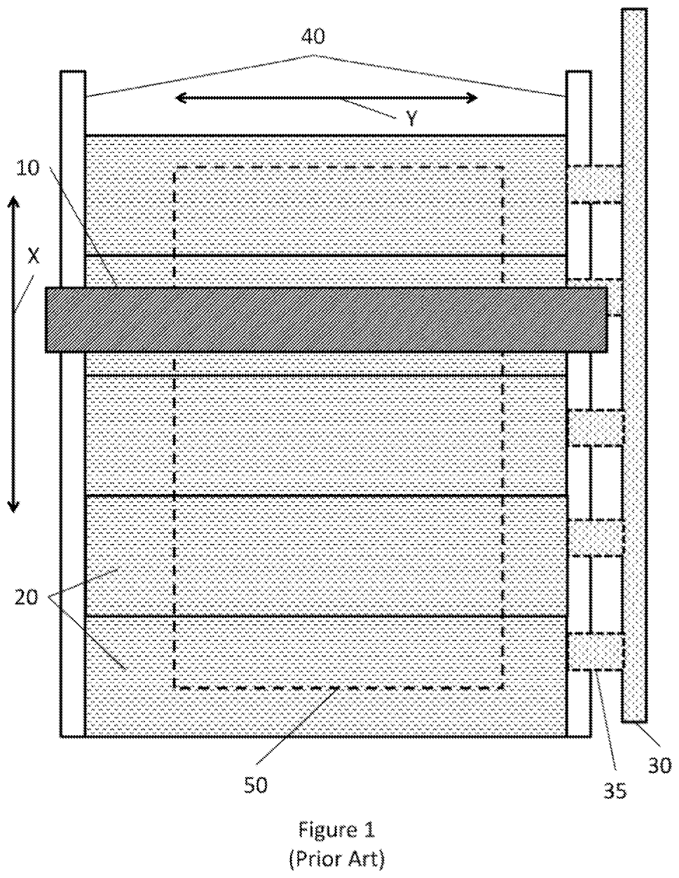

FIG. 2 illustrates a top view of a gantry-type thermal cutting system utilizing a waste hopper;

FIG. 3 illustrates a front view of the gantry-type thermal cutting system of FIG. 2;

FIG. 4 illustrates another embodiment of a top view of a gantry-type thermal cutting system utilizing a waste hopper;

FIG. 5 illustrates a front view of the gantry-type thermal cutting system of FIG. 4;

FIG. 6 illustrates a side view of the gantry-type thermal cutting system of FIG. 2; and

FIG. 7 illustrates a side view of grated steel sheets with fork pockets therebetween.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

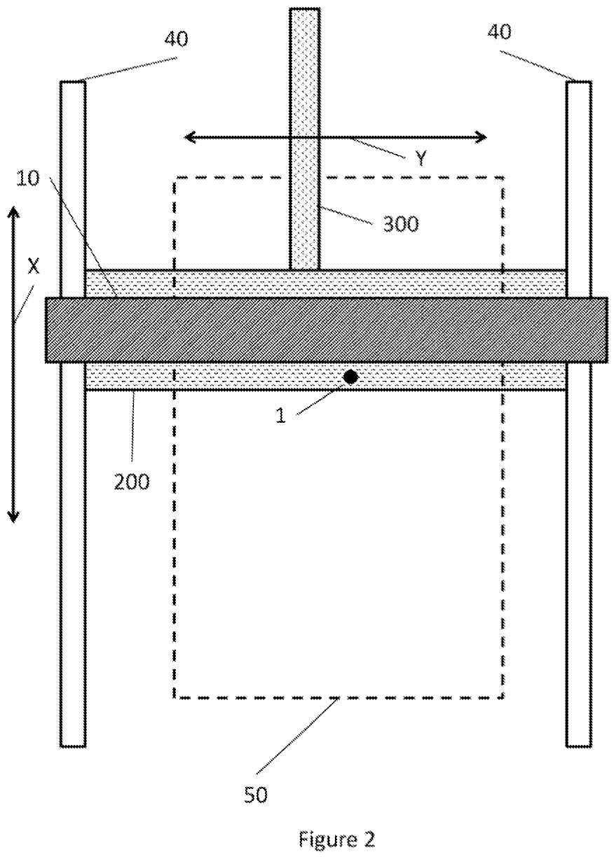

FIG. 2 illustrates a top view of a gantry-type thermal cutting system utilizing a waste hopper. As illustrated in FIG. 2, the gantry-type thermal cutting system includes a gantry 10, holding a thermal cutting device (not shown), to bi-directionally move the gantry 10 in an X-direction, along rails 40.

The thermal cutting device 1, located on the cross beam of gantry 10, may move in a Y-direction, orthogonal to the X-direction. This allows the thermal cutting device 1 to move two-dimensionally. The thermal cutting device 1 also moves up and down and may do bevel cutting.

A steel plate 50 may sit upon a cutting table (bed of grated steel sheets) (not shown). The cutting table (bed of grated steel sheets) provides support for the steel plate 50. Each grated steel sheet includes a grating that allows waste (slag and remnants from the cutting process) to fall through the cutting table (bed of grated steel sheets) into a waste hopper 200 located underneath the cutting table (bed of grated steel sheets).

As illustrated in FIG. 2, the waste hopper 20 is removably connected to the gantry 10 such that as the gantry 10 moves in the X-direction, the waste hopper 200 moves synchronously in the X-direction with the gantry 10. The waste hopper 200 may be connected to the gantry 10 in any conventional manner that allows the easy disconnection of the waste hopper 200 from the gantry 10.

The waste hopper 200 is located underneath the gantry 10 and the bed (cutting table) so that the waste hopper 200 can capture the waste (slag and remnants from the cutting process).

The waste hopper 200 has, connected thereto, a ventilation conduit 300 that is connected to a ventilation system (not shown), to draw the fumes, produced by the thermal cutting, away from the thermal cutting system. The ventilation conduit 300 is configured in an accordion manner such that as the waste hopper 200 moves away from the ventilation system, the ventilation conduit 300 expands in length, and when the waste hopper 200 moves towards the ventilation system, the ventilation conduit 300 contracts in length.

The ventilation conduit 300 may be a retracting coil or accordion style. The contracting of the ventilation conduit 300 may also be accomplished in a coil—recoil system or a free hanging conduit. An alternate to the ventilation conduit 300 is a self-contained filtration unit (not shown) which travels with the hopper 200 and can be emptied in a like manner.

The waste hopper 200 may include opening slots (not shown) to engage forks of a forklift to allow loading and unloading of the waste hopper 200 by a forklift.

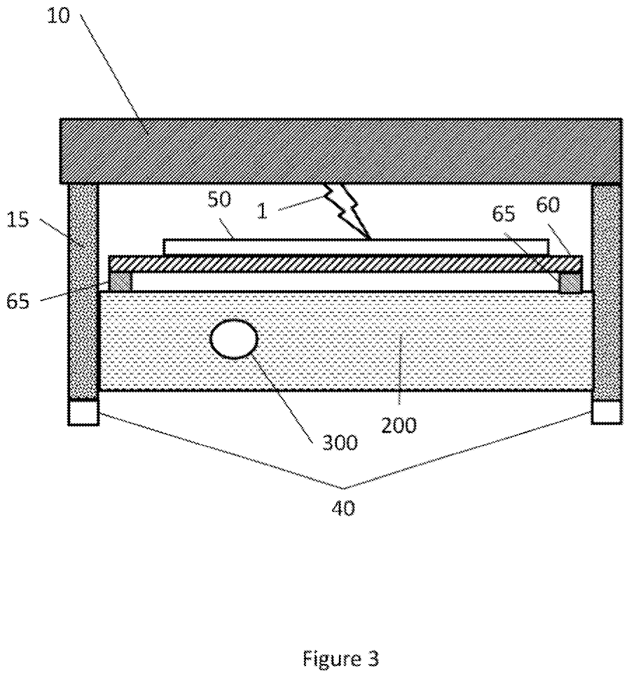

FIG. 3 illustrates a front view of the gantry-type thermal cutting system of FIG. 2. As illustrated in FIG. 3, the gantry-type thermal cutting system includes a gantry 10, holding a thermal cutting device 1. The gantry-type thermal cutting system rides along gantry rails 40, to bi-directionally move the gantry 10 in an X-direction. The thermal cutting device 1, located on the cross beam of gantry 10, may move in a Y-direction, orthogonal to the X-direction. This allows the thermal cutting device 1 to move two-dimensionally.

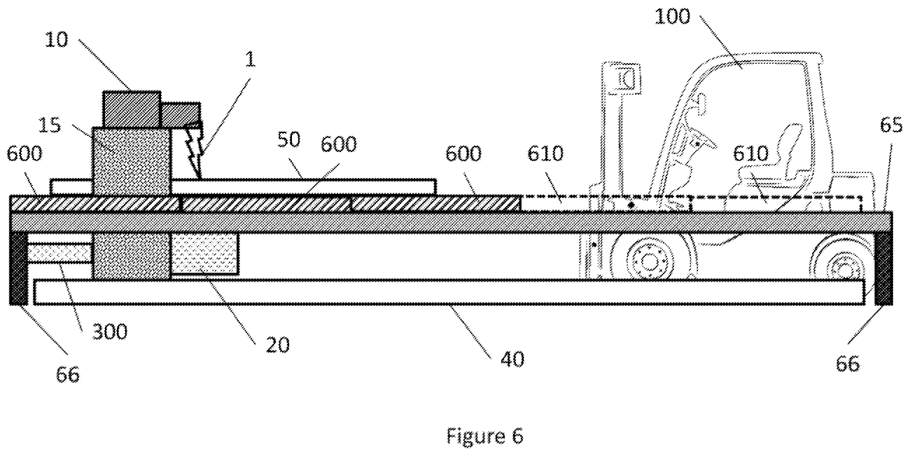

The cross beam of gantry 10 is held above, by legs 15, a steel plate 50 that sits upon a cutting table 60. The cross beam 10 and the legs 15 may be one integral section. The cutting table 60 may be separate modular steel grating plates (sections) (600 of FIG. 6) for ease of handling. The modular steel grating plates (600 of FIG. 6) may include open slots (not shown) to engage forks of a forklift to allow loading and unloading by a forklift. The cutting table 60 provides support for the steel plate 50, wherein each modular steel grating plate (600 of FIG. 6) includes a grating (not shown) that allows waste (slag and remnants from the cutting process) to fall through the modular steel grating plate (600 of FIG. 6) into waste hopper 200 located underneath the modular steel grating plate (600 of FIG. 6).

The cutting table 60 is supported by a cutting table support system consisting of steel beams 65, which are parallel to and in board of the gantry rails 40 of the gantry-type thermal cutting system, and a plurality of vertical support beams (not shown) to vertically support the steel beams 65.

As illustrated in FIG. 3, the waste hopper 200 is removably connected to the legs 15 of the gantry 10, wherein the legs 15 ride along gantry rails 40, to bi-directionally move the gantry 10 in an X-direction. The removable connection of the waste hopper 200 to the legs 15 of the gantry 10 allows the gantry 10 and the waste hopper 200 to move synchronously in the X-direction. The waste hopper 200 may be connected to the legs 15 of the gantry 10 in any conventional manner that allows the easy disconnection of the waste hopper 200 from the legs 15 of the gantry 10 or allows for an easy means of discharging the waste at a convenient point.

The waste hopper 200 is located underneath the gantry 10 and the cutting table (bed of grated steel sheets) 60 so that the waste hopper 200 can capture the waste (slag and remnants from the cutting process).

The waste hopper 200 has, connected thereto, a ventilation conduit 300 that is connected to a ventilation system (not shown), to draw the fumes, produced by the thermal cutting, away from the thermal cutting system. The ventilation conduit 300 is configured in an accordion manner such that as the waste hopper 200 moves away from the ventilation system, the ventilation conduit 300 expands in length, and when the waste hopper 200 moves towards the ventilation system, the ventilation conduit 300 contracts in length. The ventilation conduit 300 may be a retracting coil or accordion style. The contracting of the ventilation conduit 300 may also be accomplished in a coil—recoil system or a free hanging conduit.

In the embodiment illustrated in FIGS. 2 and 3, the gantry-type thermal cutting system uses a waste hopper (waste collection system), removably connected to the gantry, so as to reduce the number of waste hoppers needed to capture the waste (slag and remnants from the cutting process) while maintaining the proper coverage of the cutting table since the waste hopper moves synchronously with the gantry 10 in the X-direction to provide proper coverage of the bed (cutting table).

Moreover, in the embodiment illustrated in FIGS. 2 and 3, the gantry-type thermal cutting system uses a waste hopper (waste collection system), removably connected to the gantry, so as to reduce the number of waste hoppers needed to capture the waste (slag and remnants from the cutting process) while reducing the time needed to service a waste hopper that needs emptying since multiple waste hoppers do not need to be removed before accessing the waste hopper needing removal.

Additionally, in the embodiment illustrated in FIGS. 2 and 3, the gantry-type thermal cutting system uses a waste hopper (waste collection system), removably connected to the gantry, so as to reduce the complexity of the ventilation system while maintaining the proper coverage of the cutting table since the multiple valves or dampers and control system to control ventilation to each waste hopper is not required.

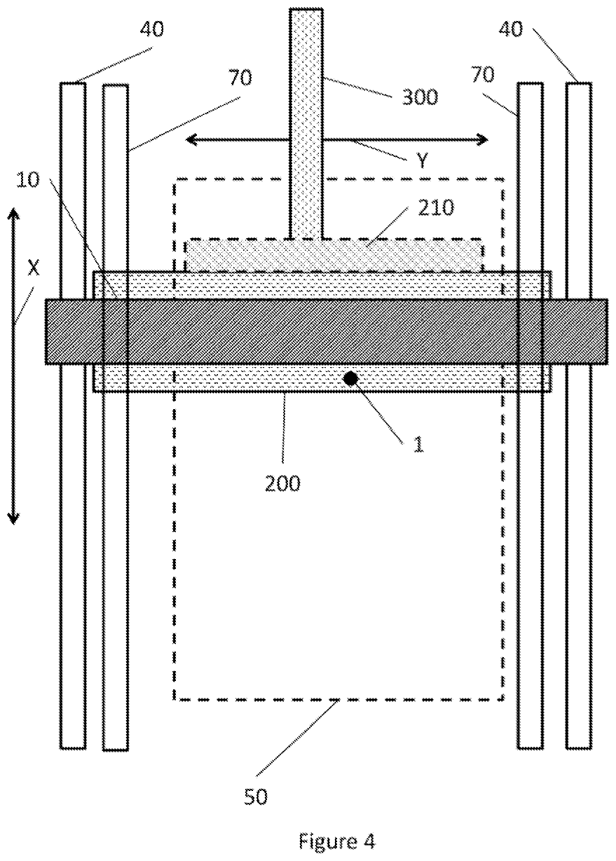

FIG. 4 illustrates a top view of another embodiment of a gantry-type thermal cutting system utilizing a waste hopper. As illustrated in FIG. 4, the gantry-type thermal cutting system includes a gantry 10, holding a thermal cutting device (not shown), to bi-directionally move the gantry 10 in an X-direction, along gantry rails 40. The thermal cutting device (not shown), located on the cross beam of gantry 10, may move in a Y-direction, orthogonal to the X-direction. This allows the thermal cutting device (not shown) to move two-dimensionally.

A steel plate 50 may sit upon a cutting table (bed of grated steel sheets) (not shown). The cutting table (bed of grated steel sheets) provides support for the steel plate 50. Each grated steel sheet includes a grating that allows waste (slag and remnants from the cutting process) to fall through the cutting table (bed of grated steel sheets) into a waste hopper 200 located underneath the bed (cutting table).

As illustrated in FIG. 4, the waste hopper 200 rides on a rail system 70 such that as the waste hopper 200 moves in the X-direction. This embodiment facilitates a very long bed (cutting table) where steel beam span to support the cutting table is too great to be practical.

The gantry-type thermal cutting system includes a control system (not shown) that drives the waste hopper 200 synchronously in the X-direction with the gantry 10. The waste hopper 200 may be connected to the rail system 70 in any conventional manner that allows the easy disconnection of the waste hopper 200 from the rail system 70.

The waste hopper 200 is located underneath the gantry 10 and the cutting table (bed of grated steel sheets) so that the waste hopper 200 can capture the waste (slag and remnants from the cutting process).

The waste hopper 200 has, connected thereto, a ventilation conduit 300 that is connected to a ventilation system (not shown), to draw the fumes, produced by the thermal cutting, away from the thermal cutting system. The ventilation conduit 300 is configured in an accordion manner such that as the waste hopper 200 moves away from the ventilation system, the ventilation conduit 300 expands in length, and when the waste hopper 200 moves towards the ventilation system, the ventilation conduit 300 contracts in length. The ventilation conduit 300 may be a retracting coil or accordion style. The contracting of the ventilation conduit 300 may also be accomplished in a coil—recoil system or a free hanging conduit. An alternate to the ventilation conduit 300 is a self-contained filtration unit 210 which travels with the hopper 200 and can be emptied in a like manner.

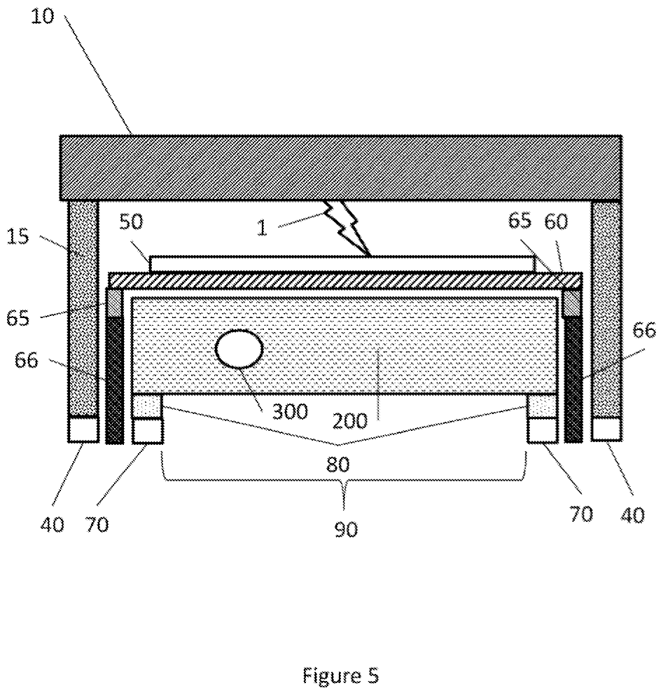

FIG. 5 illustrates a front view of the gantry-type thermal cutting system of FIG. 4. As illustrated in FIG. 5, the gantry-type thermal cutting system includes a gantry 10, holding a thermal cutting device 1. The gantry-type thermal cutting system rides along gantry rails 40, to bi-directionally move the gantry 10 in an X-direction. The thermal cutting device 1, located on the cross beam of gantry 10, may move in a Y-direction, orthogonal to the X-direction. This allows the thermal cutting device 1 to move two-dimensionally.

The cross beam of gantry 10 is held above, by legs 15, a steel plate 50 that sits upon a cutting table 60. The cross beam 10 and the legs 15 may be one integral section. The cutting table 60 may be separate modular steel grating plates (600 of FIG. 6) for ease of handling.

The modular steel grating plates (600 of FIG. 6) may include open slots (not shown) to engage forks of a forklift to allow loading and unloading by a forklift. The cutting table 60 provides support for the steel plate 50, wherein each modular steel grating plate (600 of FIG. 6) includes a grating (not shown) that allows waste (slag and remnants from the cutting process) to fall through the modular steel grating plate (600 of FIG. 6) into waste hopper 20 located underneath the modular steel grating plate (600 of FIG. 6).

The cutting table 60 is supported by a cutting table support system consisting of steel beams 65, which are parallel to the gantry rails 40 of the gantry-type thermal cutting system, and a plurality of vertical support beams 66 to vertically support the steel beams 65.

As illustrated in FIG. 5, the waste hopper 200 may include legs or a frame 80 to engage the waste hopper 200 to a rail system 70 or the waste hopper 200 may connect directly to the rail system 70 (no legs 80). The waste hopper 200 may be removably connected to the legs 80, wherein the legs 80 ride along the rail system 70, to bi-directionally move the waste hopper 200 in an X-direction. The gantry-type thermal cutting system includes a control system (not shown) that drives the waste hopper 200 synchronously in the X-direction with the gantry 10. The waste hopper 200 may be connected to the rail system 70 in any conventional manner that allows the easy disconnection of the waste hopper 200 from the rail system 70.

Alternatively, waste hopper 200 may be removable connected to the legs 80 in any conventional manner that allows the easy disconnection of the waste hopper 200 from the legs 80 or facilitates easy emptying of the contents from the waste hopper 200.

The waste hopper 200 is located underneath the gantry 10 and the cutting table (bed of grated steel sheets) 60 so that the waste hopper 200 can capture the waste (slag and remnants from the cutting process).

The waste hopper 200 has, connected thereto, a ventilation conduit 300 that is connected to a ventilation system (not shown), to draw the fumes, produced by the thermal cutting, away from the thermal cutting system. The ventilation conduit 300 is configured in an accordion manner such that as the waste hopper 200 moves away from the ventilation system, the ventilation conduit 300 expands in length, and when the waste hopper 200 moves towards the ventilation system, the ventilation conduit 300 contracts in length.

The ventilation conduit 300 may be a retracting coil or accordion style. The contracting of the ventilation conduit 300 may also be accomplished in a coil—recoil system or a free hanging conduit. An alternate to the ventilation conduit 300 is a self-contained filtration unit (not shown) which travels with the hopper 200 and can be emptied in a like manner.

As further illustrated in FIG. 5, the area (90) between the rail system 70 is left open and accessible to allow a forklift access to the grated steel sheets 60 as well as the waste hopper 200.

In the embodiment illustrated in FIGS. 4 and 5, the gantry-type thermal cutting system uses a waste hopper so as to reduce the number of waste hoppers needed to capture the waste (slag and remnants from the cutting process) while maintaining the proper coverage of the bed (cutting table) since the waste hopper moves synchronously with the gantry 10 in the X-direction to provide proper coverage of the bed (cutting table).

Moreover, in the embodiment illustrated in FIGS. 4 and 5, the gantry-type thermal cutting system uses a waste hopper (waste collection system) so as to reduce the number of waste hoppers needed to capture the waste (slag and remnants from the cutting process) while reducing the time needed to service a waste hopper that needs emptying since multiple waste hoppers do not need to be removed before accessing the waste hopper needing removal.

Additionally, in the embodiment illustrated in FIGS. 4 and 5, the gantry-type thermal cutting system uses a waste hopper (waste collection system) so as to the complexity of the ventilation system while maintaining the proper coverage of the cutting table since the multiple valves or dampers and control system to control ventilation to each waste hopper is not required.

FIG. 6 illustrates a side view of the gantry-type thermal cutting system of FIG. 2. As illustrated in FIG. 6, the gantry-type thermal cutting system includes a gantry 10, holding a thermal cutting device 1, to bi-directionally move the gantry 10 in an X-direction, along gantry rails 40. The thermal cutting device 1, located on the cross beam of gantry 10, may move in a Y-direction, orthogonal to the X-direction. This allows the thermal cutting device 1 to move two-dimensionally. The thermal cutting device 1 also moves up and down and does bevel cutting. The cross beam of gantry 10 is held above, by legs 15, a steel plate 50 that sits upon a cutting table consisting of a bed of grated steel sheets 600.

The illustration of FIG. 6 includes the illustration of removed grated steel sheets 610. The cutting table (bed of grated steel sheets) 600 provides support for the steel plate 50, wherein each grated steel sheet 600 includes a grating (not shown) that allows waste (slag and remnants from the cutting process) to fall through the grated steel sheet 600 into waste hopper 200 located underneath the cutting table (bed of grated steel sheets) 600.

The cutting table (bed of grated steel sheets) 600 are supported by a grated steel sheet support system consisting of steel beams 65, which are parallel to the gantry rails 40 of the gantry-type thermal cutting system, and a plurality of vertical support beams 66 to vertically support the steel beams 65.

As illustrated in FIG. 6, the waste hopper 200 is removably connected to the gantry 10 such that as the gantry 10 moves in the X-direction, the waste hopper 200 moves synchronously in the X-direction with the gantry 10. The waste hopper 200 may be connected to the gantry 10 in any conventional manner that allows the easy disconnection of the waste hopper 200 from the gantry 10.

The waste hopper 200 is located underneath the gantry 10 and the cutting table (bed of grated steel sheets) 600 so that the waste hopper 200 can capture the waste (slag and remnants from the cutting process).

The waste hopper 200 has, connected thereto, a ventilation conduit 300 that is connected to a ventilation system (not shown), to draw the fumes, produced by the thermal cutting, away from the thermal cutting system. The ventilation conduit 300 is configured in an accordion manner such that as the waste hopper 200 moves away from the ventilation system, the ventilation conduit 300 expands in length, and when the waste hopper 200 moves towards the ventilation system, the ventilation conduit 300 contracts in length.

The ventilation conduit 300 may be a retracting coil or accordion style. The contracting of the ventilation conduit 300 may also be accomplished in a coil—recoil system or a free hanging conduit. An alternate to the ventilation conduit 300 is a self-contained filtration unit (not shown) which travels with the hopper 200 and can be emptied in a like manner.

FIG. 6 also shows a forklift 100 traveling between the steel beams 65 to enable the removal of grated steel sheets 610 and/or access to the waste hopper 200. The forklift being able to travel between the steel beams 65 allows the forklift to remove the grated steel sheets 610, which need replacing, without the need for manual labor, overhead cranes, or hoisting. The forklift being able to travel between the steel beams 65 also allows access to the waste hopper 200 for the removal of any small parts that may have fallen through the grating of the grated steel sheet 600.

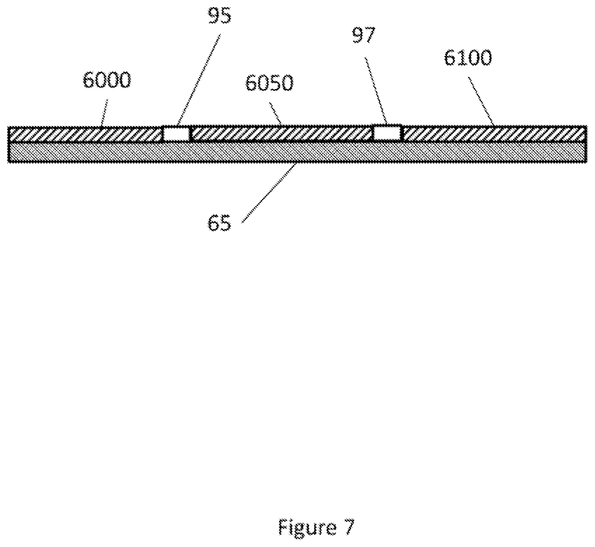

FIG. 7 illustrates a side view of grated steel sheets with a fork pockets therebetween. As illustrated in FIG. 7, grated steel sheets 6000, 6050, and 6100 are resting on support beam 65. Grated steel sheets 6000 and 6050 include a fork pocket 95, therebetween, to provide access for a forklift to easily set the steel sheet (to be cut) from the side without interference with the other grated steel sheets of the cutting table. Moreover, grated steel sheets 6050 and 6100 include a fork pocket 97, therebetween, to provide access for a forklift to easily set the steel sheet (to be cut) from the side without interference with the other grated steel sheets of the cutting table.

The various embodiments, described above, provide a smoke and slag receiver that travels with the thermal cutting system that can be easily emptied and provide a system having an open access to the cutting table for removal and replacement of the slat system by a forklift requiring little to no manual labor.

Although the various embodiments, described above, show a single waste hopper, the waste hopper can be divided into multiple waste hoppers. The purpose of the waste hopper of the various embodiments, described above, is to have the waste hopper system dynamically travel along with the gantry-type thermal cutting system instead upon relying upon a plurality of static waste hoppers, thereby reducing the number of waste hoppers needed to capture the waste (slag and remnants from the cutting process) while maintaining the proper coverage of the cutting table.

The various embodiments, described above, reduce the number of waste hoppers needed to capture the waste (slag and remnants from the cutting process) while maintaining the proper coverage of the cutting table.

Additionally, the various embodiments, described above, reduce the number of waste hoppers needed to capture the waste (slag and remnants from the cutting process) while maintaining the proper coverage of the cutting table and increasing suction at the “point of cut.”

Moreover, the various embodiments, described above, reduce the number of waste hoppers needed to capture the waste (slag and remnants from the cutting process) while reducing the time needed to service the cutting table or a waste hopper that needs emptying.

Additionally, the various embodiments, described above, reduce the number of waste hoppers needed to capture the waste (slag and remnants from the cutting process) while maintaining the proper coverage of the cutting table and reducing the time needed to service the cutting table or a waste hopper that needs emptying.

Furthermore, the various embodiments, described above, reduce the complexity of the ventilation system while maintaining the proper coverage of the cutting table. Also, the various embodiments, described above, enable the removal and cleaning of the waste effortlessly on a daily basis using a forklift or other method.

The various embodiments, described above, have open access to the hopper to collect small parts that fall through the grating of a grated steel sheet.

Furthermore, the various embodiments, described above, reduce the complexity of the ventilation system while maintaining the proper coverage of the cutting table and increasing suction at the “point of cut.”

Additionally, the various embodiments, described above, have access to the cutting table grating by forklift and remove entire sections of steel grating at a time without manual labor.

Furthermore, the various embodiments, described above, enable effortlessly retrieval of small parts that fall through the grating of a grated steel sheet.

A gantry-type thermal cutting system includes a gantry; a thermal cutting device located on the gantry; a cutting table having a grated steel sheet; and a waste hopper removably connected to the gantry; the gantry being configured to move bi-directionally in a first direction; the thermal cutting device being configured to move bi-directionally in a second direction, the first direction being orthogonal to the second direction; the waste hopper being configured to move synchronously with the gantry in the first direction; the waste hopper being positioned under the gantry to capture waste from a thermal cutting process performed by the thermal cutting device.

The gantry may include gantry legs; the waste hopper being removably connected to the gantry legs. The gantry-type thermal cutting system may comprise a ventilation unit, operatively connected to the waste hopper, configured to draw the fumes produced by the thermal cutting process performed by the thermal cutting device. The gantry-type thermal cutting system may comprise a self-contained filtration unit, operatively connected to the waste hopper, configured to travel with the waste hopper. The gantry-type thermal cutting system may comprise gantry rails configured to enable the gantry to move bi-directionally in the first direction. The waste hopper may include opening slots configured to engage forks of a forklift.

The gantry-type thermal cutting system may comprise a ventilation conduit operatively connected to the waste hopper and the ventilation unit; the ventilation conduit being configured such that when the waste hopper moves away from the ventilation unit, the ventilation conduit expands in length; the ventilation conduit being configured such that when the waste hopper moves towards the ventilation unit, the ventilation conduit contracts in length. The gantry-type thermal cutting system may comprise a ventilation conduit operatively connected to the waste hopper and the ventilation unit; the ventilation conduit being configured to retract as a coil when the waste hopper moves towards the ventilation unit.

A gantry-type thermal cutting system includes a gantry; a thermal cutting device located on the gantry; a cutting table having a grated steel sheet; and a waste hopper; a waste hopper rail system; and a control system, operatively connected to the gantry and the waste hopper; the waste hopper rail system being configured to bi-directionally move the waste hopper in a first direction; the gantry being configured to move bi-directionally in the first direction; the control system controlling the waste hopper rail system to move synchronously with the gantry in the first direction; the thermal cutting device being configured to move bi-directionally in a second direction, the first direction being orthogonal to the second direction; the control system controlling the waste hopper rail system to maintain a position of the waste hopper under the gantry to capture waste when a thermal cutting process is performed by the thermal cutting device.

The gantry may include gantry legs. The waste hopper rail system may include waste hopper legs; the waste hopper being removably connected to the waste hopper legs. The gantry-type thermal cutting system may comprise a ventilation unit, operatively connected to the waste hopper, configured to draw the fumes produced by the thermal cutting process performed by the thermal cutting device. The gantry-type thermal cutting system may comprise a self-contained filtration unit, operatively connected to the waste hopper, configured to travel with the waste hopper. The gantry-type thermal cutting system may comprise gantry rails configured to enable the gantry to move bi-directionally in the first direction. The waste hopper may include opening slots configured to engage forks of a forklift.

The gantry-type thermal cutting system may comprise a ventilation conduit operatively connected to the waste hopper and the ventilation unit; the ventilation conduit being configured such that when the waste hopper moves away from the ventilation unit, the ventilation conduit expands in length; the ventilation conduit being configured such that when the waste hopper moves towards the ventilation unit, the ventilation conduit contracts in length. The gantry-type thermal cutting system may comprise a ventilation conduit operatively connected to the waste hopper and the ventilation unit; the ventilation conduit being configured to retract as a coil when the waste hopper moves towards the ventilation unit. The gantry-type thermal cutting system may comprise gantry rails configured to enable the gantry to move bi-directionally in the first direction.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. A gantry-type thermal cutting system comprising:
a gantry;
a thermal cutting device located on said gantry;
a cutting table having a grated steel sheet; and
a waste hopper removably connected to said gantry;
said gantry being configured to move bi-directionally in a first direction;
said thermal cutting device being configured to move bi-directionally in a second direction, said first direction being orthogonal to said second direction;
said waste hopper being configured to move synchronously with said gantry in said first direction;
said waste hopper being positioned under said gantry to capture waste from a thermal cutting process performed by said thermal cutting device.

2. The gantry-type thermal cutting system, as claimed in claim 1, wherein said gantry includes gantry legs;
said waste hopper being removably connected to said gantry legs.

3. The gantry-type thermal cutting system, as claimed in claim 1, further comprising:
a ventilation unit, operatively connected to said waste hopper, configured to draw the fumes produced by the thermal cutting process performed by said thermal cutting device.

4. The gantry-type thermal cutting system, as claimed in claim 3, further comprising:
a ventilation conduit operatively connected to said waste hopper and said ventilation unit;
said ventilation conduit being configured such that when said waste hopper moves away from said ventilation unit, said ventilation conduit expands in length;
said ventilation conduit being configured such that when said waste hopper moves towards said ventilation unit, said ventilation conduit contracts in length.

5. The gantry-type thermal cutting system, as claimed in claim 3, further comprising:
a ventilation conduit operatively connected to said waste hopper and said ventilation unit;
said ventilation conduit being configured to retract as a coil when said waste hopper moves towards said ventilation unit.

6. The gantry-type thermal cutting system, as claimed in claim 3, further comprising:
a self-contained filtration unit, operatively connected to said waste hopper, configured to travel with said waste hopper.

7. The gantry-type thermal cutting system, as claimed in claim 1, wherein said waste hopper includes opening slots configured to engage forks of a forklift.

8. The gantry-type thermal cutting system, as claimed in claim 1, further comprising:
gantry rails configured to enable said gantry to move bi-directionally in said first direction.

9. A gantry-type thermal cutting system comprising:
a gantry;
a thermal cutting device located on said gantry;
a cutting table having a grated steel sheet; and
a waste hopper;
a waste hopper rail system; and
a control system, operatively connected to said gantry and said waste hopper;
said waste hopper rail system being configured to bi-directionally move said waste hopper in a first direction;
said gantry being configured to move bi-directionally in said first direction;
said control system controlling said waste hopper rail system to move synchronously with said gantry in said first direction;
said thermal cutting device being configured to move bi-directionally in a second direction, said first direction being orthogonal to said second direction;
said control system controlling said waste hopper rail system to maintain a position of said waste hopper under said gantry to capture waste when a thermal cutting process is performed by said thermal cutting device.

10. The gantry-type thermal cutting system, as claimed in claim 9, wherein said gantry includes gantry legs.

11. The gantry-type thermal cutting system, as claimed in claim 9, wherein said waste hopper rail system includes waste hopper legs;
said waste hopper being removably connected to said waste hopper legs.

12. The gantry-type thermal cutting system, as claimed in claim 9, further comprising:
a ventilation unit, operatively connected to said waste hopper, configured to draw the fumes produced by the thermal cutting process performed by said thermal cutting device.

13. The gantry-type thermal cutting system, as claimed in claim 12, further comprising:
a ventilation conduit operatively connected to said waste hopper and said ventilation unit;
said ventilation conduit being configured such that when said waste hopper moves away from said ventilation unit, said ventilation conduit expands in length;
said ventilation conduit being configured such that when said waste hopper moves towards said ventilation unit, said ventilation conduit contracts in length.

14. The gantry-type thermal cutting system, as claimed in claim 12, further comprising:
a ventilation conduit operatively connected to said waste hopper and said ventilation unit;
said ventilation conduit being configured to retract as a coil when said waste hopper moves towards said ventilation unit.

15. The gantry-type thermal cutting system, as claimed in claim 12, further comprising:
a self-contained filtration unit, operatively connected to said waste hopper, configured to travel with said waste hopper.

16. The gantry-type thermal cutting system, as claimed in claim 9, wherein said waste hopper includes opening slots configured to engage forks of a forklift.

17. The gantry-type thermal cutting system, as claimed in claim 9, further comprising:
gantry rails configured to enable said gantry to move bi-directionally in said first direction.
